(19) United States
(12) Patent Application Publication
(10) Pub. No.: US 2014/0063519 A1
(43) Pub. Date: Mar. 6, 2014

(54) Copier with Detachable Image Scanner

(71) Applicant: SHINTEN SANGYO CO., LTD., Tokyo (JP)

(72) Inventor: Minoru Amishima, Tokyo (JP)

(73) Assignee: SHINTEN SANGYO CO., LTD., Tokyo (JP)

(21) Appl. No.: 13/693,018

(22) Filed: Dec. 3, 2012

(30) Foreign Application Priority Data
Aug. 30, 2012 (JP) 2012-204972

(51) Int. Cl. H04N 1/00

(52) U.S. Cl. CPC H04N 1/00278
USPC 358/1.13

(57) ABSTRACT

A copier including a printing unit and a detachable image scanner that is physically detachable from the printing unit and communicably connectable to the printing unit. The image scanner includes a substrate; a microprocessor mounted on the substrate; a digital camera module mounted on the substrate and connected to the microprocessor; and a light-emitting diode (LED) array mounted on the substrate and connected to the microprocessor. The image scanner is configured to illuminate an object to be scanned with the LED array and image the object to be scanned with the digital camera module to produce an image signal that is then transmitted to a central processing unit (CPU) through the microprocessor and from the CPU to the printing unit for output as a printed copy.

### CROSS-REFERENCE TO RELATED APPLICATION

This patent application is based on and claims priority pursuant to 35 U.S.C. §119 from Japanese Patent Application No. 2012-204972, filed on Aug. 30, 2012, the entire disclosure of which is hereby incorporated by reference herein.

### BACKGROUND OF THE INVENTION

1. Field of the Invention

The present invention relates to a copier configured with a detachable image scanner, and more particularly, to an improved, more sophisticated copier employing a specialized digital camera in the image scanner, with the image scanner being detachable from the copier.

2. Description of the Related Art

Conventional copiers combine the image scanner and the printer in a single unit. Conventionally, scanning involves moving the image scanner across the face of the document to be scanned. As a result, the configuration not only limits the image scanner to a particular position and requires a complicated image scanner drive mechanism but also limits the types and sizes of documents and objects that can be scanned.

### SUMMARY OF THE INVENTION

By contrast, the present invention provides a novel copier configuration in which the digital camera module is fixedly mounted inside the image scanner, with the image scanner being detachable form the copier. This configuration allows the image scanner to be used anywhere to scan anything. To print out a copy of the scanned image, the image scanner and the printer are in wire or wireless communication with each other to provide copying at a remote location, whether in another room or on another floor, by either the person who performed the scan or by someone else, substantially in real time or at some point after the scan is completed.

More specifically, the present invention provides a copier configured as a printing unit and a detachable image scanner that is physically detachable from the printing unit and communicably connectable to the printing unit. The image scanner is constructed of a substrate, a microprocessor mounted on the substrate, a digital camera module mounted on the substrate and connected to the microprocessor, and a light-emitting diode (LED) array mounted on the substrate and connected to the microprocessor. The image scanner is configured to illuminate an object to be scanned with the LED array and image the object to be scanned with the digital camera module to produce an image signal that is then transmitted to a central processing unit (CPU) through the microprocessor and from the CPU to the printing unit for output as a printed copy.

Making the image scanner detachable allows the digital camera module to have an uncomplicated construction, which in turn makes the scanner easily portable and usable horizontally, vertically, diagonally, etc., to provide the ability to scan and make two-dimensional copies of even three-dimensional objects.

Configured appropriately, the detachable image scanner can be linked to different models of copiers or printers as well as communicably connected to mobile phone devices, resulting in a greatly expanded range of applications.

Moreover, the copier can be connected to external electronic devices such as tablets, personal computers, and the like, to enable import and export of image files between the copier and the external device.

### BRIEF DESCRIPTION OF THE SEVERAL VIEWS OF THE DRAWINGS

A more complete appreciation of the disclosure and many of the attendant advantages thereof will be more readily obtained as the same becomes better understood by reference to the following detailed description of illustrative embodiments when considered in connection with the accompanying drawings, wherein:

FIG. 1 is a perspective view of a copier with a detachable image scanner according to embodiments of the present invention, in a state in which the image scanner is detached from the printer;

FIG. 2 is a perspective view of the image scanner of FIG. 1 scanning a tablet from above;

FIG. 3 is a perspective view of the image scanner of FIG. 1 scanning a tablet from below;

FIG. 4 is a perspective view of the image scanner of FIG. 1 scanning an aquarium tank from the side;

FIG. 5 is a perspective view of the image scanner of FIG. 1 scanning another three-dimensional object from the front;

FIG. 6 is a perspective view of the image scanner of FIG. 1 scanning a tablet from the front;

FIG. 7 is a perspective view of a digital camera module unit installed in the image scanner of FIG. 1; and

FIG. 8 is a sectional view of the digital camera module of FIG. 7.

### DETAILED DESCRIPTION OF THE INVENTION

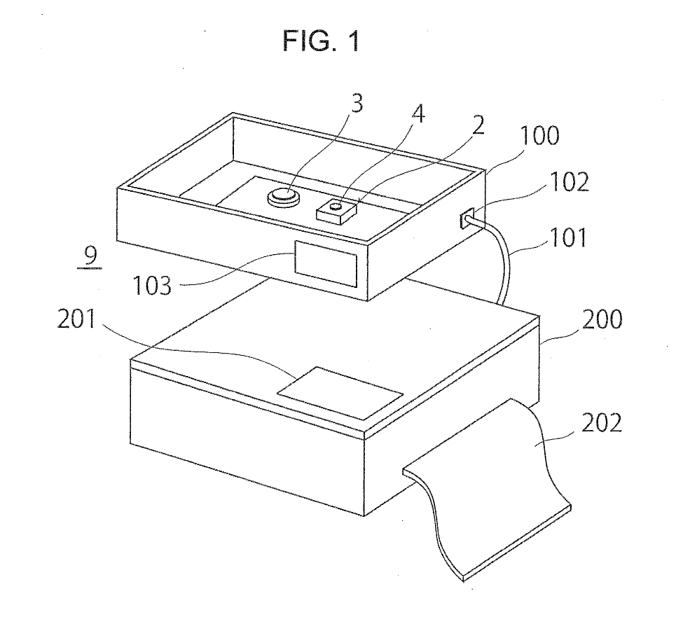

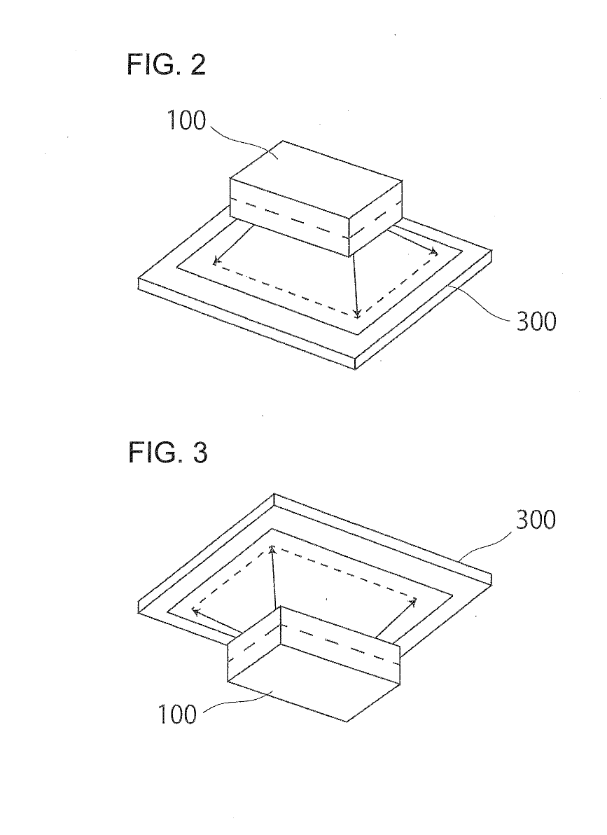

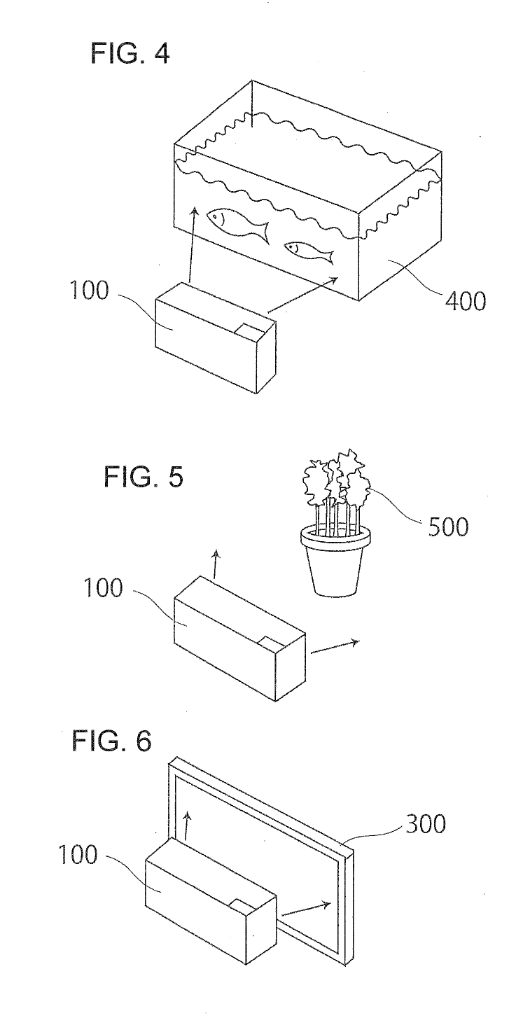

A description will now be given of preferred embodiments of the present invention, in the first instance with reference to FIGS. 1, 7, and 8. In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

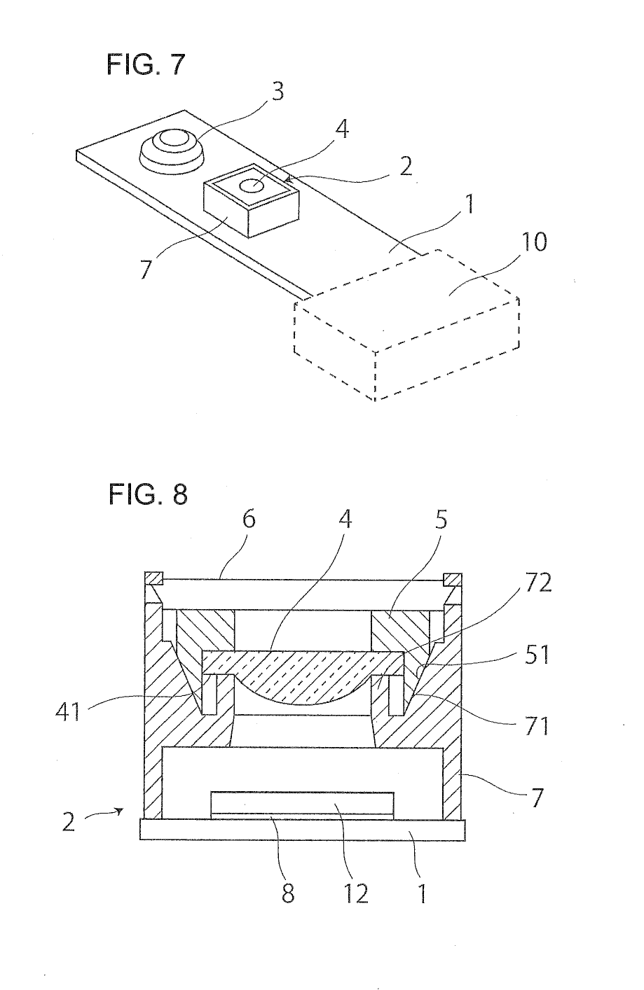

FIG. 1 is a perspective view of a copier with a detachable image scanner according to embodiments of the present invention, showing separate scanning and printing units. FIG. 7 is a perspective view of a digital camera module unit installed in the image scanner of FIG. 1. FIG. 8 is a sectional view of the digital camera module of FIG. 7.

As shown in FIG. 1, a copier 9 has an image scanner 100 that is detachable from a printer 200. The image scanner 100 is constructed of a substrate 1 mounting a microprocessor, which, in the present embodiment, is a digital signal processor (DSP) 8. On the substrate 1 are further mounted a digital camera module 2 and a light-emitting diode (LED) array 3. The image scanner 100 illuminates an object to be scanned with the LED array 3 and the object to be scanned is then photographed with the digital camera module 2. The thus-acquired image signal is then transmitted to a central processing unit (CPU) 10 (shown in FIG. 7) through the DSP 8 (shown in FIG. 8), and from there to the printer 200 for output. It should be noted that the image scanner 100 and the printer 200 may be communicably connected to each other by either wire or wireless communication. In the present embodiment, as shown in FIG. 1, the image scanner 100 and the printer 200 are communicably connected by a communications cable 101. However, the exact type of communication link established between the detachable image scanner 100 and the printer 200 is not limited thereto, and may be effected by any well-known wire or wireless interface, including Local Area Network (LAN) cable, Small Computer System Interface (SCSI), Universal Serial Bus (USB), Fire Wire, or Bluetooth wireless communications technologies.

Thus, an image on an electronic tablet or other external electronic device, or a three-dimensional object, can be imaged by detaching the image scanner 100 from the printer 200, and then a two-dimensional copy of the two- or three-dimensional image can be printed out at the printer 200 onto a recording medium such as a sheet of copier paper 202.

A detailed description will now be given of the digital camera module 2, which is fixedly mounted inside the image scanner 100.

As shown in FIG. 8, an imaging element 12 is mounted to an inner surface of the substrate 1 via the DSP chip 8. A lens holder 7 having a conical concavity 72 formed therein is also affixed to the substrate 1 of the digital camera module 2 by reflow soldering or the like. A lens 4 made of heat-resistant plastic is fitted into a lens mount 5 of a lens barrel 6 having a conical projecting portion 71 that engages the conical concavity 72 of the lens holder 7.

The conical projecting portion 51 of the proximal end of the lens mount 5 of the heat-resistant plastic lens 4 is fitted snugly into the conical concavity 72 of the lens holder 7, thereby regulating the coaxiality of the installed heat-resistant plastic lens 4.

A flange 41 of the heat-resistant plastic lens 4 is directly seated on and supported by the lens holder 7, thereby regulating the parallelity of the installed heat- resistant plastic lens 4 and aligning it with the imaging element 12.

The lens barrel 6, in which the heat-resistant plastic lens 4 and the lens mount 5 are formed as a single integrated unit, is snapped onto the top of the lens holder 7 to ensure that the lens barrel 6 is fixedly mounted in place.

Further, the present invention, in which an object is imaged by the digital camera module 2 fitted with the heat-resistant plastic lens 4 and the resulting image signal is transmitted to the controller 10 via the DSP 8 and processed by the controller 10 as described above, provides together with a scanning capability for scanning documents a sensor capability configured to enable adjustment of the size of the document, its position, color, and contrast of text of the document from either a control panel 103 on the image scanner 100 or a control panel 201 on the printer 200, for printout on the copy paper 202 loaded into the printer 200.

The resolution of the copier 9 may be enhanced by appropriate processing of the image by the controller 10. The controller 10 includes a Central Processing Unit (CPU) that executes software programs and associated memory devices; i.e., a Read Only Memory (ROM) that stores control programs and control data used by the CPU, a Random Access Memory (RAM) used as a working memory that temporarily stores image data for output generated by the control programs and data necessary for the software programs, and a Nonvolatile RAM (NVRAM) that stores setting data such as processing conditions. The type of image processing performed by the controller 10 includes, but is not limited to, pixel interpolation.

With the copier of the present invention configured as described above, the digital camera module 2 is fixedly mounted in the detachable image scanner 100, enabling the image scanner 100 to be freely used almost anywhere to scan almost anything. To print out, the image scanner 100 and the printer 200 can be communicably connected by either a communications cable 101 or wirelessly. Thus, the copier of the present invention can provide a copying capability at a remote location, whether in another room or on another floor, by either the person who performed the scan or by someone else, substantially in real time or at some point after the scan is completed.

As can be appreciated by those skilled in the art, numerous additional modifications and variations of the present invention are possible in light of the above teachings. It is therefore to be understood that, within the scope of the appended claims, the present invention may be practiced otherwise than as specifically described herein.

What is claimed is:

1. A copier comprising:
a printing unit; and
a detachable image scanner that is physically detachable from the printing unit and communicably connectable to the printing unit,
the image scanner comprising:
a substrate;
a microprocessor mounted on the substrate;
a digital camera module mounted on the substrate and connected to the microprocessor; and
a light-emitting diode (LED) array mounted on the substrate and connected to the microprocessor, wherein the image scanner is configured to:
illuminate an object to be scanned with the LED array; and
image the object to be scanned with the digital camera module to produce an image signal that is then transmitted to a central processing unit (CPU) through the microprocessor and from the CPU to the printing unit for output as a printed copy.

2. The copier according to claim 1, wherein the microprocessor is a digital signal processor (DSP) chip.

3. The copier according to claim 1, wherein the printing unit and the image scanner are connected by a communications cable.

4. The copier according to claim 1, wherein the printing unit and the image scanner are connected wirelessly.

5. The copier according to claim 1, configured to scan an image on an electronic tablet or other external electronic device or a three-dimensional image by contacting the image scanner against the tablet screen or imaging the three- dimensional object with the image scanner detached from the printing unit, to provide a two-dimensional copy of the image or object via the printing unit.

6. The copier according to claim 1, wherein the digital camera module comprises:
a microprocessor mounted on an inner surface of the substrate;
an imaging element mounted on the microprocessor;
a lens holder having a conical concavity formed therein affixed to the substrate;
a lens made of heat-resistant plastic fitted into a lens mount of a lens barrel having a conical projecting portion that engages the conical concavity of the lens holder,
the conical projecting portion of the proximal end of the lens mount of the heat- resistant plastic lens fitted snugly into the conical concavity of the lens holder to regulate coaxiality of the installed heat-resistant plastic lens; and
the heat-resistant plastic lens having a flange that is directly seated on and supported by the lens holder to align the heat-resistant plastic lens with the imaging element,
wherein the lens barrel is snapped onto the top of the lens holder to fixedly mount the lens barrel in place.
